(19) United States
(12) Patent Application Publication
(10) Pub. No.: US 2019/0199697 A1
(43) Pub. Date: Jun. 27, 2019

(54) MANAGEMENT METHOD AND MANAGEMENT SYSTEM FOR ELECTRONIC DEVICE

(71) Applicant: INSYDE SOFTWARE CORP., Taipei City (TW)

(72) Inventors: Chih-Kao WANG, Taipei City (TW); Chia-Ting YU, Taipei City (TW)

(73) Assignee: INSYDE SOFTWARE CORP., Taipei City (TW)

(21) Appl. No.: 16/219,213

(22) Filed: Dec. 13, 2018

(30) Foreign Application Priority Data
Dec. 27, 2017 (TW) 106146053

(51) Int. Cl. H04L 29/06; G06F 21/10; G06F 9/54; G06F 9/30

(52) U.S. Cl. CPC H04L 63/062; G06F 9/30043; G06F 9/542; G06F 21/10

(57) ABSTRACT

A management method is performed by an electronic device of a management system. When the electronic device determines that a trigger condition is fulfilled, the electronic device loads a set of key commands and executes a predetermined event according to the key commands. The set of key commands is defined by a user to trigger the predetermined event, and provides protection to the electronic device. The management system includes the electronic device and a key device, which are wirelessly connected. If the key device does not execute a device management program, the electronic device executes a security procedure to provide protection to the electronic device.

### CROSS-REFERENCE TO RELATED APPLICATIONS

This application claims the priority benefit of TW application serial No. 106146053, filed on Dec. 27, 2017. The entirety of the above-mentioned patent application is hereby incorporated by reference herein and made a part of specification.

### BACKGROUND OF THE INVENTION

### 1. Field of the Invention

The present invention relates to a management method and a management system, and particularly a management method and a management system for an electronic device.

### 2. Description of the Related Art

Computer is one of the most popular electronic devices used in all fields, and is often used to store a large amount of data such as personal information, business information, and account information. When such data is obtained by any individual without authorization of the legitimate owner, it might be maliciously leaked and therefore cause information security hazards.

In most situations, the user of a computer will execute a computer security program or simply logout from the operating system to protect the data inside the computer, and the user has to enter an account and password to login the operating system in order to continue operation. As a result, an unauthorized individual won't be able to obtain the data in the computer without the correct account and password. However, it's common for a user to forget to execute the computer security program or logout when leaving the computer only shortly, thus enabling someone nearby to access the computer freely without notice and lead to potential information security hazards.

### SUMMARY OF THE INVENTION

An objective of the present invention is to prevent the confidential information in an electronic device from being obtained by any unauthorized individual.

To achieve the foregoing objective, the present invention provides a management method for an electronic device, including the following steps:

determining whether a trigger condition is fulfilled;

when the trigger condition is fulfilled, loading a set of key commands;

executing a predetermined event according to the set of key commands;

wherein the set of key commands is predetermined by a user according to a preset function of the electronic device;

wherein the trigger condition is fulfilled when a power state of the electronic device changes.

When the electronic device determines that the trigger condition is fulfilled, the electronic device loads the set of key commands and executes the predetermined event triggered by the set of key commands. The set of key commands is predetermined by the user in order to assign the predetermined event to be executed. The predetermined event can be assigned to log out of the operation system, or turn off the monitor of the device, thus preventing an unauthorized individual from operating the electronic device or gaining access to the information stored in the electronic device.

The management system for the electronic device provided in the present invention includes a key device and an electronic device. The key device determines whether to execute a device management program. The electronic device is wirelessly connected to the key device, and when the key device does not execute the device management program, the electronic device executes a security procedure, while the security procedure includes the following steps:

determining whether a trigger condition is fulfilled;

when the trigger condition is fulfilled, loading a set of key commands;

executing a predetermined event according to the set of key commands.

In the security procedure, the set of key commands is predetermined by a user according to a preset function of the electronic device, and the trigger condition is fulfilled when a power state of the electronic device changes.

When the key device executes the device management program and the electronic device determines the device management program of the key device is well functioning, the electronic device continues the normal operation. If the device management program of the key device is operated abnormally, for example, the device management program is suspended or removed, the electronic device executes the security procedure. When executing the security procedure, the electronic device further determines whether the power state changes, and loads the set of key commands when the power state changes in order to trigger the predetermined event. The predetermined event is assigned by the user while predetermining the set of key commands, which has an effect of keeping the data in the electronic device secured.

Other objectives, advantages and novel features of the invention will become more apparent from the following detailed description when taken in conjunction with the accompanying drawings.

### BRIEF DESCRIPTION OF THE DRAWINGS

FIG. 1 is a flow diagram of a management method of the present invention.

FIG. 2 is a flow diagram of a first embodiment of the management method.

FIG. 3 is a flow diagram of a second embodiment of the management method.

FIG. 4 is a block diagram of a management system of the present invention.

FIG. 5 is a flow diagram of a third embodiment of a procedure of a key device of the management system.

FIG. 6 is a flow diagram of a third embodiment of the procedure of an electronic device of the management system.

FIG. 7 is a flow diagram of a fourth embodiment of the management method.

FIG. 8 is a flow diagram of a fifth embodiment of the management method.

### DETAILED DESCRIPTION OF THE INVENTION

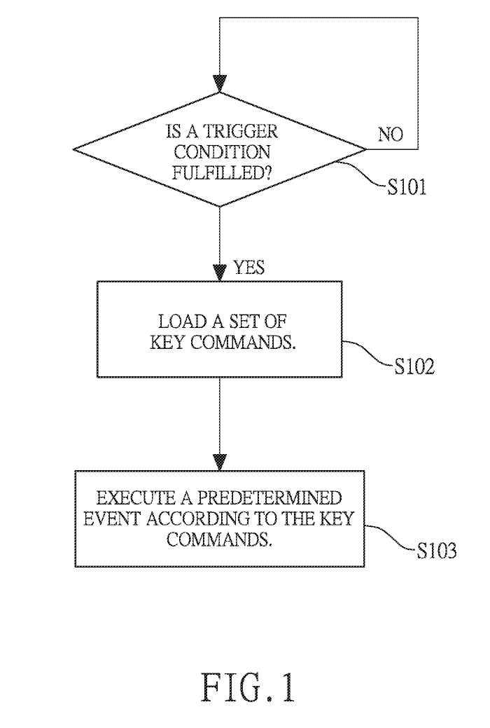

Since the conventional computer security program has to be executed manually in order to secure the information from any unauthorized individual, and is of no use when the user does not execute the program, the present invention provides a management method for an electronic device. With reference to FIG. 1, the method includes the following steps:

determining whether a trigger condition is fulfilled (S101);

when the trigger condition is fulfilled, loading a set of key commands (S102);

executing a predetermined event according to the set of key commands (S103).

When the electronic device determines that the trigger condition is fulfilled, the electronic device loads the set of key commands and executes the predetermined event according to the key commands.

An electronic device with a keypad or numeric buttons is usually preset with special key combination functions, or hot key functions. That is, when a set of keys or buttons are pressed and the commands are read by the device in that certain order, a preset event according to the key combination will be triggered. For example, if the device is input with a first key combination, the device will execute a “logout” procedure. Therefore, when the user defines the first key combination as the set of key commands to be loaded when the trigger condition is fulfilled, the electronic device will automatically load the first key combination when the trigger condition is fulfilled, and the predetermined event will be to logout from the operating system. As a result, the user has to enter the correct account and the password to login the operation system again in order to resume the operation, preventing an unauthorized individual from accessing confidential information stored in the electronic device.

According to different sets of key commands defined by the user, the predetermined event can be defined as locking a monitor of the electronic device, logging out of the operating system, turning off the monitor of the electronic device, turning down luminance of the monitor of the electronic device, or turning up volume of sound of the electronic device, achieving different effects of keeping others from accessing the device, or reminding the user to confirm the security condition of the device.

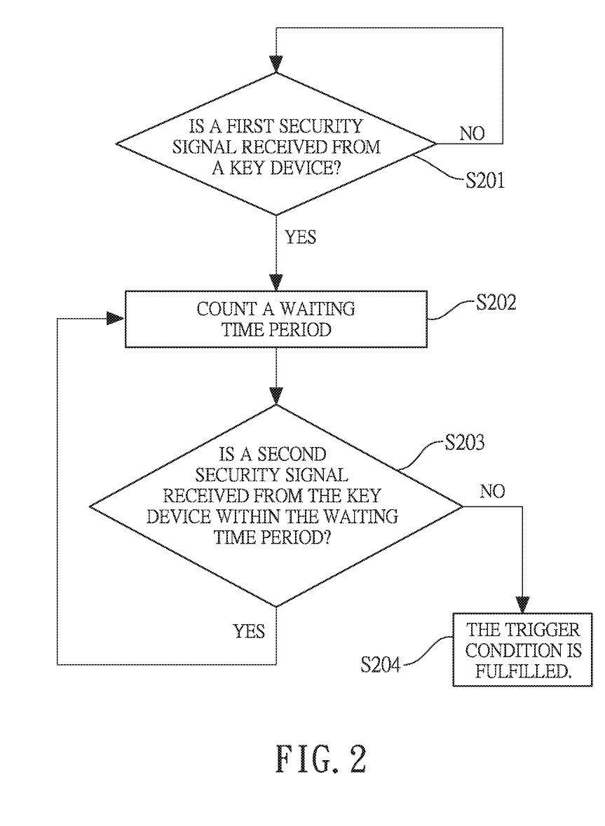

With reference to FIG. 2, in a first embodiment of the present invention, whether the trigger condition is fulfilled is determined according to the following steps:

determining whether a first security signal is received from a key device (S201);

when the first security signal is received, counting a waiting time period (S202);

determining whether a second security signal is received from the key device within the waiting time period (S203);

when the second security signal is not received within the waiting time period, determining that the trigger condition is fulfilled (S204).

The electronic device that performs the management method is a device that requires protection, such as a personal computer, a tablet, or a smart phone. The key device can be a mobile device that a user usually carries around, such as a smart phone, a smart watch, a wireless mouse, or a mobile audio player. The first security signal and the second security signal sent by the key device have an effective distance, that is, if the distance between the key device and the electronic device is longer than the effective distance, the electronic device won't be able to receive the first security signal or the second security signal.

When the electronic device receives the first security signal, it is confirmed that the key device is within the effective distance and is operating properly. The electronic device then continues the original process and starts to count the waiting time period. If the electronic device does not receive the second security signal within the waiting time period, the key device is probably malfunctioning or the key device has left the effective distance. Therefore, the electronic device determines that the trigger condition is fulfilled, and the electronic device loads the set of key commands. If the electronic device does receive the second security signal within the waiting time period, it is confirmed that the key device is still within the effective distance and is still operating properly, the electronic device continues the original process.

The electronic device receives the first and second security signals through wireless connection, preferably through Bluetooth connection.

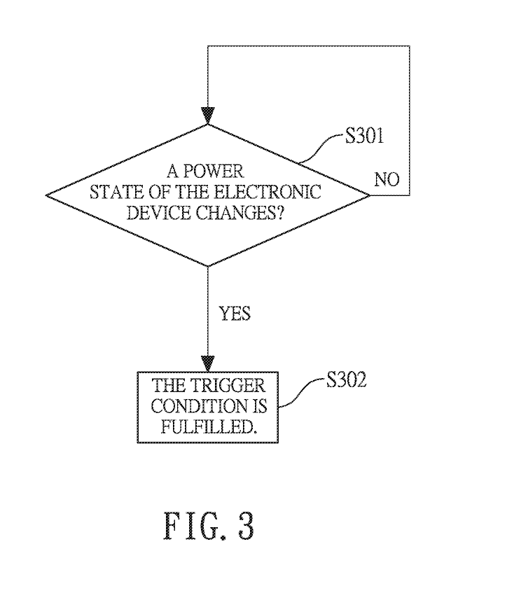

With reference to FIG. 3, in a second embodiment of the present invention, whether the trigger condition is fulfilled is determined according to the following steps:

determining whether a power state of the electronic device changes (S301);

when the power state changes, determining that the trigger condition is fulfilled (S302).

In the present embodiment, the electronic device can be a personal computer. In different power states, a power module of the electronic device supplies power to different modules of the electronic device, meeting the acquirements of different usage statuses as well as avoiding unnecessary power consumption. When the power state of the electronic device changes, the electronic device determines that the trigger condition is fulfilled and loads the set of key commands to execute the predetermine events.

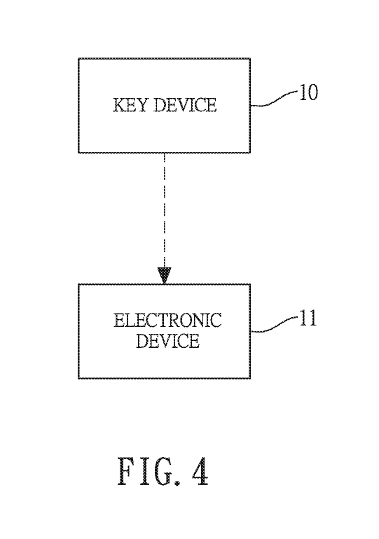

With reference to FIG. 4, the management system for the electronic device includes a key device 10 and an electronic device 11. The key device 10 determines whether to execute a device management program. The electronic device 11 is wirelessly connected to the key device 10. When the key device 10 does not execute the device management program, the electronic device 11 executes a security procedure.

When the key device 10 executes the device management program, the electronic device 11 determines the device management program of the key device 10 is well functioning, and the electronic device 11 continues the original operation. If the device management program of the key device 10 is operated abnormally, for example, the device management program is suspended or removed, the electronic device 11 executes the security procedure in order to keep the electronic device 11 secured.

For instance, the key device 10 is a smart phone which is installed with the device management program, and the electronic device 11 is a personal computer which is wirelessly connected to the key device 10. When the smart phone executes the device management program properly, the personal computer continues normal operating. If the smart phone encounters abnormal operation or a breakdown, and the device management program is removed or shut down, the personal computer executes the security procedure to prevent operation by the person other than the legitimate owner.

The electronic device 11 can be a personal computer, a tablet, or a smart phone. The key device 10 can be a smart watch, a smart phone, a wireless mouse, or a mobile audio player.

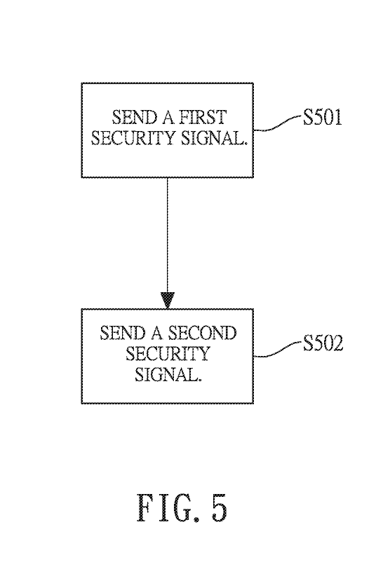

With reference to FIG. 5, in a third embodiment of the present invention, when the key device 10 executes the device management program, the key device 10 generates and sends a first security signal (S501). The key device 10 further generates and sends a second security signal within a waiting time period (S502).

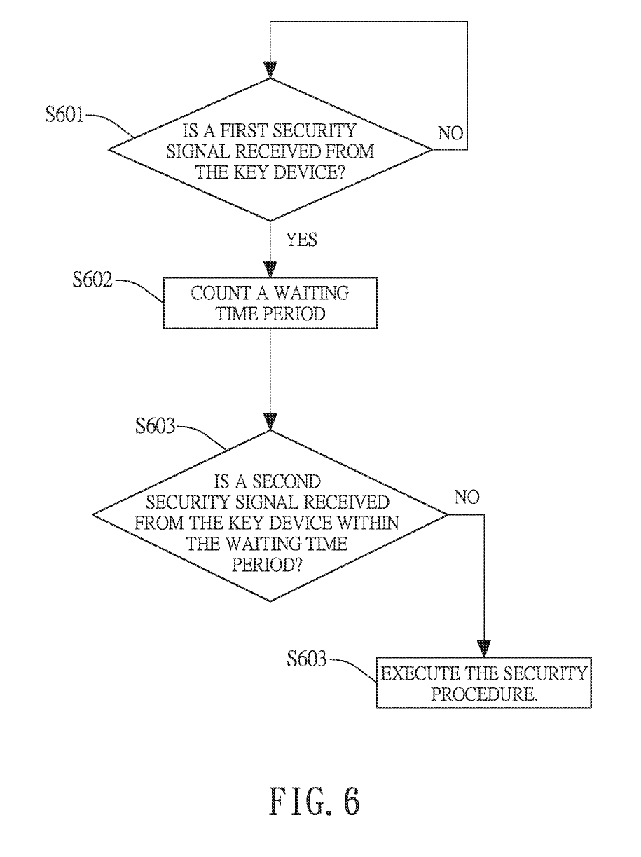

With reference to FIG. 6, the electronic device 11 determines whether the first security signal is received from the key device 10 (S601). When the electronic device 11 receives the first security signal, the electronic device 11 starts to count a waiting time period (S602). The electronic device 11 further determines whether the second security signal is received from the key device 10 within the waiting time period (S603). If the second security signal is not received within the waiting time period, the electronic device 11 executes the security procedure (S604).

When the electronic device 11 receives the first and second security signals within the waiting time period, it means that the key device 10 is functional and properly executes the device management program. On the other hand, when the electronic device 11 does not receive the second security signal within the waiting time period, it means that the key device 10 does not execute the device management program as expected, and the electronic device 11 executes the security procedure to secure the data within the electronic device 11.

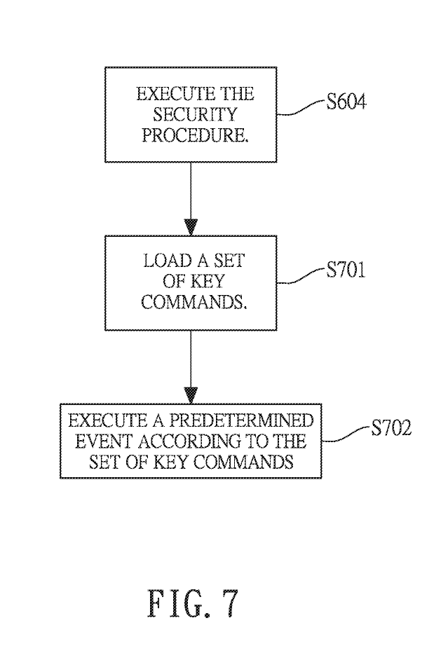

With reference to FIG. 7, in a fourth embodiment of the present invention, when the electronic device 11 executes the security procedure (S604), the electronic device 11 loads a set of key commands (S701) and executes a predetermined event according to the set of key commands (S702).

The set of key commands is defined by the user according to the preset function of the electronic device 11. For example, in a personal computer installed with a Microsoft operating system, if the user presses the “windows” key and the letter “L” key, it triggers a logout event. Therefore, if the user defines the “windows” key and the “L” key to be the set of key commands, the personal computer will load the “windows” key and the “L” key commands when executing the security procedure, and the set of key commands will lead to a logout event of the Microsoft operating system. In short, the user determines the security procedure to be executed by defining the set of key commands to be loaded.

As a result, the security procedure can be logging out from the operation system, locking the monitor of the electronic device 11, turning down luminance of the monitor of the electronic device 11, turning off the monitor of the electronic device 11, or turning up the volume of the sound of the electronic device 11.

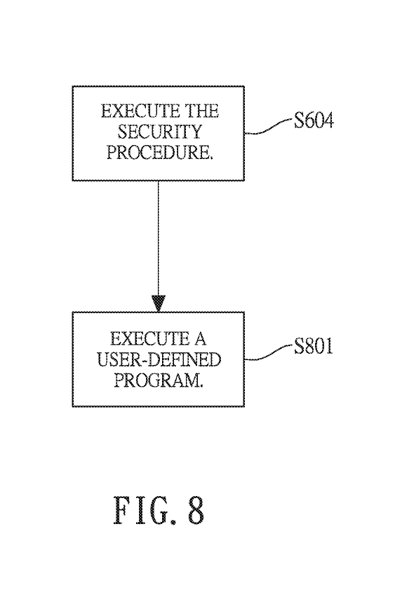

With reference to FIG. 8, in a fifth embodiment of the present invention, when the electronic device 11 executes the security procedure (S604), the electronic device 11 executes a user-defined program (S801).

A user can choose the user-defined program to be executed when the security procedure is executed in advance, so that when the key device 10 does not execute the device management program, the electronic device 11 will execute the user-defined program which protects the data in the electronic device 11.

For example, the user-defined program can be a screensaver program, a music playing program, or a keypad lockdown program. When the screensaver program is the user-defined program, it keeps others from reading the information on the screen. When the music playing program is the user-defined program, the electronic device 11 plays music so as to remind the user to keep an eye on the electronic device 11. When the keypad lockdown program is the user-defined program, the electronic device 11 locks down the keypad to prevent others from operating the electronic device 11.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A management method performed by an electronic device, comprising the following steps:
determining whether a trigger condition is fulfilled;
when the trigger condition is fulfilled, loading a set of key commands;
executing a predetermined event according to the set of key commands;
wherein the set of key commands is predetermined by a user according to a preset function of the electronic device;
wherein the trigger condition is fulfilled when a power state of the electronic device changes.

2. The management method as claimed in claim 1, wherein the predetermined event is logging out of an operation system, locking a monitor of the electronic device, turning down or turning off the monitor of the electronic device, or turning up a volume of the electronic device.

3. A management system of an electronic device, comprising:
a key device, determining whether to execute a device management program;
an electronic device, wirelessly connected to the key device; wherein
when the key device does not execute the management program, the electronic device executes a security procedure; wherein
the security procedure comprises the following steps:
determining whether a trigger condition is fulfilled;
when the trigger condition is fulfilled, loading a set of key commands;
executing a predetermined event according to the set of key commands; wherein
the set of key commands is predetermined by a user according to a preset function of the electronic device; wherein
the trigger condition is fulfilled when a power state of the electronic device changes.

4. The management system as claimed in claim 3, wherein when the key device executes the device management program, the key device generates and sends a first security signal;
the key device further generates and sends a second security signal within a waiting time period;
wherein the electronic device determines whether the first security signal is received from the key device, and when the electronic device receives the first security signal, the electronic device starts to count the waiting time period;
wherein the electronic device further determines whether the second security signal is received from the key device within the waiting time period;
wherein when the second security signal is not received within the waiting time period by the electronic device, the electronic device executes the security procedure.

5. The management system as claimed in claim 3, wherein the predetermined event is logging out from an operation system, locking a monitor of the electronic device, turning down the luminance of the monitor of the electronic device, turning off the monitor of the electronic device, or turning up the volume of the electronic device.
